(19) United States
(12) Patent Application Publication
(10) Pub. No.: US 2025/0224076 A1
(43) Pub. Date: Jul. 10, 2025

(54) TRUSS-LATTICE MATERIALS CONSISTING OF MIXED POLYGONS

(71) Applicant: TOBB EKONOMI VE TEKNOLOJI UNIVERSITESI, Cankayan, Ankara (TR)

(72) Inventor: Cihan TEKOGLU, Cankayan, Ankara (TR)

(21) Appl. No.: 18/701,873

(22) PCT Filed: Oct. 18, 2022
(86) PCT No.: PCT/TR2022/051154

§ 371 Date: Apr. 16, 2024

(30) Foreign Application Priority Data
Oct. 19, 2021 (TR) 2021/016251

(51) Int. Cl. F16S 3/08

(52) U.S. Cl. CPC F16S 3/08

(57) ABSTRACT

Disclosed are lattice materials including a truss structure obtained by arranging struts to form at least two triangles on each side of a polygon (i.e., a triangle, a quadrilateral, or a hexagon), which are used in many engineering fields, especially in materials engineering. The elastic modulus values per unit weight of many of the lattice materials produced from the truss structure are higher than those of the most existing cellular solids with stochastic cell distributions and many existing lattice materials. Using the truss structure disclosed herein, it is possible to produce two-dimensional (planar) lattice materials as well as spherical or tubular lattice structures in the form of a first cylindrical tube or a second cylindrical tube.

### TECHNICAL FIELD

The present invention relates to lattice materials used in many engineering disciplines, particularly in materials engineering. The newly developed lattice materials consist of truss structures obtained by arranging struts to form at least two triangles on each side of a polygon (i.e., a triangle, a quadrilateral, or a hexagon). The elastic moduli per unit weight of lattice materials produced from the truss structures of the present invention are greater than those of most cellular solids with stochastic cell distributions and the vast majority of existing lattice materials. Using the truss structures described in the invention, it is possible to manufacture tubular or spherical lattice materials as well as two-dimensional (planar) lattice materials.

### PRIOR ART

Several natural materials have superior mechanical properties compared to man-made materials. For instance, the fracture toughness of bone is an order of magnitude greater than that of many engineering ceramics. The constituents of natural materials are not superior in terms of their mechanical properties. The arrangement of the building blocks, also known as microarchitecture, gives natural materials superior mechanical performance. The fact that natural materials have such an efficient structure has inspired scientists and engineers, who have developed an abundance of new micro-architecture-designed engineering materials in recent years. The best examples of engineering materials with microarchitecture design are cellular solids. In their seminal book, Gibson and Ashby defined cellular solid materials as “materials whose edges and surfaces of cells consist of a network of interconnected solid rods or plates.” (Cellular Solids: Structure and Properties, 1999, 2nd Edition. Cambridge: Cambridge University Press). Due to their microarchitecture, cellular solids can possess desirable characteristics such as low density, high specific bending stiffness, high specific shear and fracture strength, a large accessible surface area, and a high damping capacity. Cellular solids can combine superior properties that are difficult (and sometimes even contradictory) to find in dense solid materials; they are used in various engineering fields, including vibration control systems, energy-absorbing systems, and heat exchangers.

Lattice materials belong to the family of solid materials with cells. In contrast to other cellular materials, where the shape and size of the cells are distributed stochastically, the lattice materials formed from the truss structures provided by the present invention have identical cells with a periodic spatial distribution. Numerous engineering applications favor lattice materials because their stiffness and strength per unit weight are superior to those of cellular materials with the stochastic distribution. These applications include energy absorbers, vibration and sound control devices, structures with low thermal expansion, heat exchangers, and lightweight structural panels. Literature uses the terms “two-dimensional (2D) lattice” and “planar lattice” to refer to lattice materials formed by joining unit cells in the same plane. The out-of-plane thickness of 2D lattices is relatively small compared to their in-plane lengths.

The unit cells of two-dimensional lattice materials at issue in this application are truss structures formed by arranging struts to form at least two triangles on each side of a polygon (i.e., a triangle, a quadrilateral, or a hexagon). The truss structures described in the invention and the lattice materials produced from these truss structures are named based on the type of polygon in the center of the truss structure and the number of triangles on each side of the polygon. For instance, the truss structure and lattice material derived from the truss structure in which the central polygon is a triangle and the number of triangles on each side of the central triangle is two are referred to as “Hierarchical-2 Triangles”. Similarly, the truss structure with a quadrilateral in the center and two triangles on each side of the central quadrilateral is referred to as “Mixed Quadrilateral-2 Triangles”, and the truss structure with a hexagon in the center and two triangles on each side of the central hexagon is referred to as “Mixed Hexagon-2 Triangles”. When all its struts are made of the same isotropic material, the in-plane elastic mechanical properties of the “Hierarchical-Triangular” and “Mixed Hexagonal-Triangular” lattice families with unit cells having six-fold rotational symmetry are isotropic, whereas those of the “Mixed Quadrilateral-Triangular” lattice family with unit cells having four-fold rotational symmetry are anisotropic (a body with k-fold rotational symmetry, where k is an integer, retains its original shape when rotated by an integer multiple of 360/k degrees in the plane).

Two-dimensional lattice materials appeal to engineering applications primarily due to their in-plane mechanical properties. Two independent parameters, elastic (Young's) modulus (E), and shear modulus (G), can be used to describe the mechanical properties of an isotropic material in the elastic deformation regime. The Poisson's ratio (v) is dependent on these two independent parameters, as demonstrated by Equation 1:

$$v = \frac{E - 2 G}{2 G} . \qquad ( Equation 1 )$$

While the majority of engineering materials have a positive Poisson's ratio, there are also materials with a negative Poisson's ratio (NPO). These materials, known as NPO or Auxetic materials, expand laterally under tension and contract laterally under compression. Due to their high shear and indentation resistance and high energy absorption capacity, NPO materials offer significant benefits in numerous applications, including fasteners, sensors, medical applications such as artificial blood vessels, bulletproof helmets and vests, and intelligent textiles.

Considering the effect on mechanical properties, the relative density (ρ*) is the most important physical property of lattice materials. Relative density (ρ*=ρ/ρₛ) expresses the ratio between the density of the lattice material (ρ) and the density of the solid material used to produce the lattice (ρₛ). The relative density of a two-dimensional lattice is equal to the ratio of the area occupied by solid wall material (struts) to the total area of the unit cell. Similarly, the relative elastic modulus of a lattice material (E*=E/Eₛ) is the ratio of the elastic modulus of the lattice material (E) to the elastic modulus of the solid material from which the lattice is made (Eₛ). As shown in Equation 2, the relative elastic modulus of low-density lattice materials (and cellular solids in general) is proportional to their relative density:

$${E *= C ( ρ \text{*)}}^{n} . \qquad ( Equation 2 )$$

The constant C and exponential n in Equation 2 depend on the microarchitecture of the lattice. The exponent n determines whether a lattice material is stretching-dominated or bending-dominated, i.e., whether the struts that make up the lattice resist an external load by lengthening and shortening or bending. While lattices with an exponent n equal to or near 1 exhibit a deformation behavior dominated by stretching, the lattice cell walls deform more by bending as the exponent n approaches 3. Considering that the axial stiffness of the struts is greater than their bending stiffness, the macroscopic stiffness (and strength) of the stretching-dominated lattices is greater than that of the bending-dominated lattices.

In-plane elastic mechanical properties of “Hierarchical-Triangular” and “Mixed Hexagonal-Triangular” lattice material families formed from the truss structures given in this invention are determined using a finite element analysis program. It is assumed that the cell walls of the unit cells of the lattice materials have a rectangular cross-sectional area. The unit cell is subjected to periodic boundary conditions, and each cell wall is modeled using a single “Euler-Bernoulli” beam element. Modulus of elasticity (E) and Poisson's ratio (v) are determined by applying tensile test boundary conditions to the unit cell, while the modulus of shear (G) is determined by applying simple shear boundary conditions. The values of Poisson's ratio determined by finite element calculations are validated using Equation 1. Both boundary value problems (tensile and simple shear) are solved based on the undeformed configuration of the unit cell, i.e., geometric nonlinearities are disregarded.

Finite element calculations performed in the relative density range of 0.01≤ρ*≤0.20 for the “Hierarchical-Triangular” and “Mixed Hexagonal-Triangular” lattice material families formed from the truss structures given in the present application revealed that all members of the “Hierarchical-Triangular” lattice material family exhibit a negative Poisson's ratio, particularly at low relative density values. In addition, it has been shown that many members of the “Hierarchical-Triangular” lattice material family exhibit a relatively more stretching-dominated behavior and have higher elastic and shear modulus values than other isotropic, negative Poisson's ratio lattice materials in the scientific literature. Similarly, it is determined that many members of the “Mixed Hexagonal-Triangular” lattice material family exhibit a relatively more stretching-dominated behavior and higher elastic and shear modulus values compared to the hexagonal lattice material. In addition, it was discovered that a member of the “Mixed Hexagonal-Triangular” lattice material family named “Mixed Hexagonal-2 Triangles” possesses a negative Poisson's ratio.

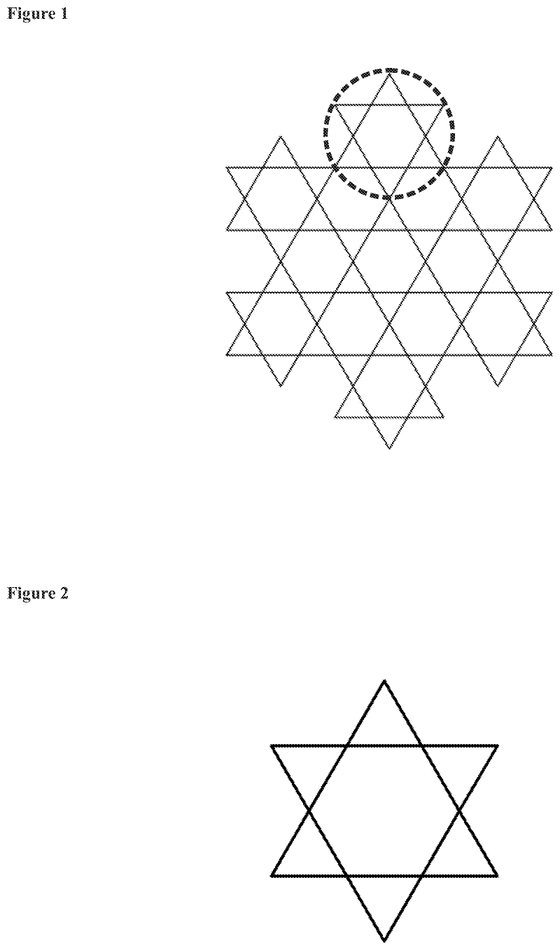

Kagome lattice material at issue in the prior art is shown in FIG. 1 (S. Hyun, S. Torquato, 2002. Optimal and manufacturable two-dimensional Kagome-like cellular solids. Journal of Materials Research 17 (1), 137-144). The truss structure that forms the unit cell of Kagome lattice material is obtained by arranging struts to form a triangle on each side of a hexagon, as shown in FIG. 2. In the claimed invention, the truss structure forming the lattice materials is obtained by arranging struts to create at least two triangles on each side of a polygon (i.e., a triangle, a quadrilateral, or a hexagon).

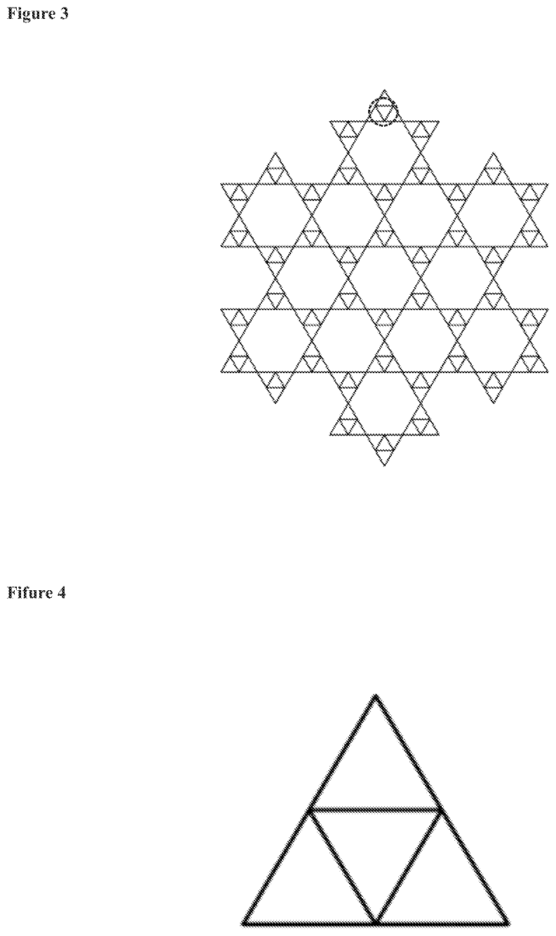

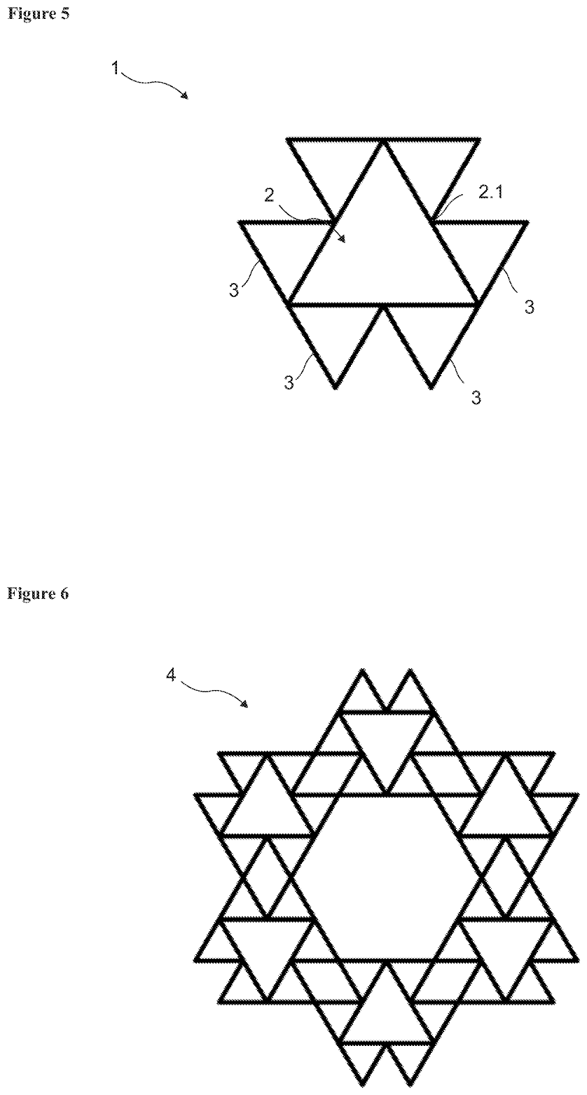

FIG. 3 depicts the prior art lattice material referred to as “Kagome with concentric triangles” (W. E. D. Nelissen, C. Ayas, C. Tekoglu, 2019. 2D lattice material architectures for actuation. Journal of the Mechanics and Physics of Solids 124, 83-101). The truss structure that forms the unit cell of the “Kagome with concentric triangles” is obtained by arranging struts to form a triangle on each side of a triangle, as shown in FIG. 4. In the claimed invention, the truss structure forming the lattice materials is obtained by arranging struts to create at least two triangles on each side of a polygon (i.e., a triangle, a quadrilateral, or a hexagon).

A lattice material with a negative Poisson's ratio is described in the Chinese utility model document with No. CN210715702 (U) and the priority date of 16 Oct. 2019 according to the prior art. The unit cell of the lattice material, which consists of beams, is formed by placing a triangle on each side of a rhombus. In the claimed invention, the truss structure forming the lattice materials is obtained by arranging struts to create at least two triangles on each side of a polygon (i.e., a triangle, a quadrilateral, or a hexagon).

The Chinese patent document with No CN109825087 (A) and the priority date 31 Jan. 2019 describes an example of a lattice structure in the prior art. In this study, which is included in the aforementioned document, triangular structures are interconnected with straight lines to form an open hexagonal unit cell. Although this lattice material resembles the lattice material known as Kagome in the literature, which can be obtained by fitting a triangle to each side of a hexagon, the triangle-to-hexagon connections of the unit cells of these two materials are distinct. Due to this difference in unit cells, the in-plane Poisson's ratio of the Kagome lattice is positive, whereas the in-plane Poisson's ratio of the above-said lattice is negative. The prior art-based invention observed the utilization of hexagonal and triangular structures. Nonetheless, the connection of open hexagon and triangular forms in the unit cell of the referenced document differs significantly from the unit cell structure of the lattices of the present invention. In the claimed invention, the truss structure forming the lattice materials is formed by arranging struts to create at least two triangles on each side of a polygon (i.e., a triangle, a quadrilateral, or a hexagon).

In the Chinese utility model document No. CN210715682 (U) and dated 16 Oct. 2019, according to the prior art, there is a three-dimensional, energy-absorbing, negative Poisson's ratio structure. The lattice is composed primarily of triangular structures in this study included in the document mentioned above. Combining these structures creates a three-dimensional central architecture that resembles a triangle on each side of a quadrilateral in the center. In the claimed invention, the truss structure forming the lattice materials is obtained by arranging struts to create at least two triangles on each side of a polygon (i.e., a triangle, a quadrilateral, or a hexagon).

In the state of the art, there is no explanation regarding the technical features and effects provided by the invention of the present application. In prior art applications, lattice materials consisting of a lattice structure whose unit cells are obtained by arranging struts to form at least two triangles on each side of a polygon (triangle, quadrilateral, or hexagonal) are not encountered.

Most readily available NPO lattice materials exhibit anisotropic mechanical properties and low stiffness. Increasing the stiffness of existing NPO lattice materials using various techniques or designing new lattice materials with isotropic mechanical properties and high stiffness is an active area of research. In addition, since lattices are multifunctional materials, the concept of “better” properties varies between applications. In some applications, high stiffness is favored, whereas, in others, the Poisson's ratio or thermal properties may take precedence. Each newly designed lattice structure (i.e., one with a particular microarchitecture) possesses unique physical and mechanical properties and offers advantages in several application areas. The in-plane elastic mechanical properties of “Hierarchical-Triangular” and “Mixed Hexagonal-Triangular” lattice families formed from the truss structure provided by the present invention are isotropic when all of its struts are made from the same isotropic material, whereas the in-plane elastic mechanical properties of “Mixed Quadrilateral-Triangular” lattice family are orthotropic. Due to their superior properties, the members of the lattice families formed from the truss structure described in the present invention can be used in various engineering applications, mainly as multifunctional materials.

### Objectives of the Invention

The objective of the present invention is to develop lattice materials comprising a truss structure formed by arranging struts to create at least two triangles on each side of a polygon (i.e., a triangle, a quadrilateral, or a hexagon).

A further objective of the present invention is to produce novel lattice materials with isotropic in-plane elastic mechanical properties and a negative Poisson's ratio (NPO).

A further objective of the present invention is to produce novel lattice materials with enhanced mechanical properties and high elastic and shear moduli.

A further objective of the present invention is to create novel lattice materials with a high energy absorption capacity that can also be produced in tubular or spherical shapes.

### BRIEF DESCRIPTION OF THE INVENTION

A truss structure, as defined in the first claim and the remaining claims, realized to achieve the purpose of the present invention, consists of the truss inner element and the outer struts. The truss structure of the present invention is obtained by placing outer struts on the inner element edges of the inner element of the truss. Combining truss structures yields unit cells, and lattice materials used in numerous engineering applications are generated by tessellating the plane with the unit cells. The truss structure of the present invention ensures that the elastic modulus values per unit weight of the lattice materials formed from it are greater than the elastic modulus values per unit weight of existing cellular solids with stochastic distribution and many existing lattice materials. In the truss structure of the invention, as described in the present application, there is a truss structure's inner element with at least three inner element edges. The inner element of the truss structure is formed by combining the edges of the inner element. The geometric form of the inner element of a truss structure is either triangular, quadrilateral or hexagonal. According to the present invention, the inner element of the truss structure has outer struts placed on the inner element edges. On the edge of the inner element, at least two triangles are formed by the placement of the outer struts. Combining six truss structures yields a unit cell if the inner element of the truss structure in the present application's invention has a triangular geometric shape. A single truss structure corresponds to a unit cell if the inner element of the truss structure in the present invention has a quadrilateral or hexagonal geometry. Tessellating the plane with the unit cells produces in-plane isotropic or orthotropic lattice materials with superior mechanical properties and lattice materials with a negative Poisson's ratio (NPO). By folding the created 2D lattice material along any axis in the plane, cylindrical tubular lattice structures can be produced. Using lattice materials consisting of the truss structure of the invention, as described in the present application, it is also possible to build spherical lattice structures. The elastic modulus, shear modulus, and Poisson's ratio of the lattice material change as the number of triangles formed by the outer struts in the truss structure of the invention at issue in the present application increases. Optionally, auxiliary struts may be positioned within the truss inner element in the truss structure of the present invention, as described in the application. The stiffness of the lattice material produced by the lattice structure is increased by auxiliary struts.

### DETAILED DESCRIPTION OF THE INVENTION

The truss structure and lattice materials realized to achieve the objectives of the present invention are depicted in the following figures:

FIG. 1. The Kagome lattice material according to the prior art (S. Hyun, S. Torquato, 2002. Optimal and manufacturable two-dimensional Kagome-like cellular solids. Journal of Materials Research 17 (1), 137-144).

FIG. 2. A unit cell of the Kagome lattice material according to the prior art (S. Hyun, S. Torquato, 2002. Optimal and manufacturable two-dimensional Kagome-like cellular solids. Journal of Materials Research 17 (1), 137-144).

FIG. 3. The lattice material referred to as “Kagome with concentric triangles” in the known status of the art (W. E. D. Nelissen, C. Ayas, C. Tekoglu, 2019. 2D lattice material architectures for actuation. Journal of the Mechanics and Physics of Solids 124, 83-101).

FIG. 4. A unit cell of the “Kagome with concentric triangles” lattice material encountered in the known status of the art (W. E. D. Nelissen, C. Ayas, C. Tekoglu, 2019. 2D lattice material architectures for actuation. Journal of the Mechanics and Physics of Solids 124, 83-101).

FIG. 5. A view of the “Hierarchical-2 Triangles truss structure”, which consists of a triangular inner element and outer struts forming two triangles on each edge of the inner element.

FIG. 6. A view of the “Hierarchical-2 Triangles unit cell,” which was formed by joining together six “Hierarchical-2 Triangles truss structures”.

FIG. 7. A view of a part of the “Hierarchical-2 Triangles lattice material” formed by combining “Hierarchical-2 Triangles unit cells”.

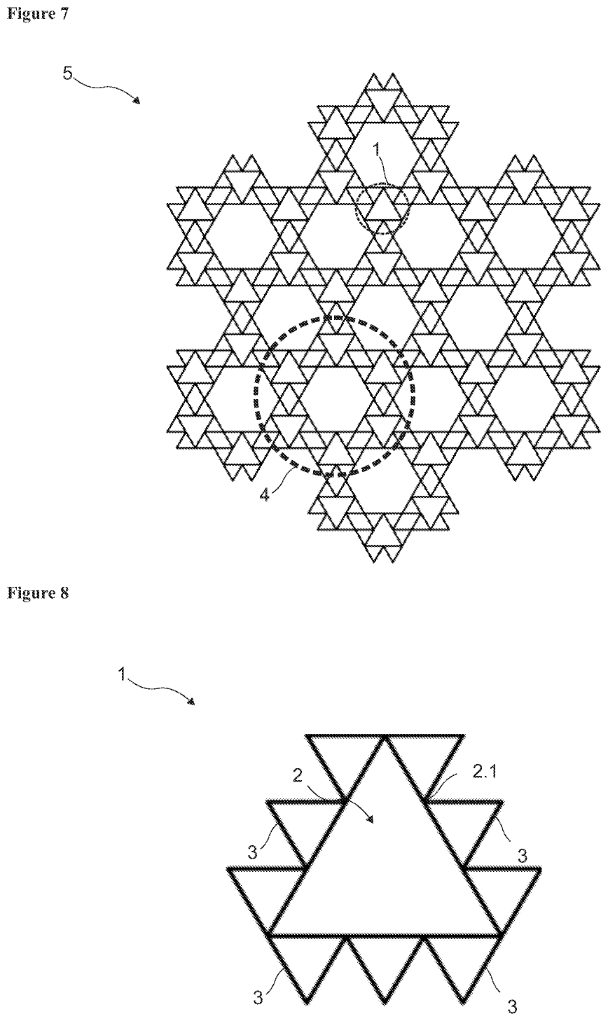

FIG. 8. A view of the “Hierarchical-3 Triangles truss structure”, which consists of a triangular inner element and outer struts forming three triangles on each edge of the inner element.

FIG. 9. A view of the “Hierarchical-3 Triangles unit cell,” which was formed by joining together six “Hierarchical-3 Triangles truss structures”.

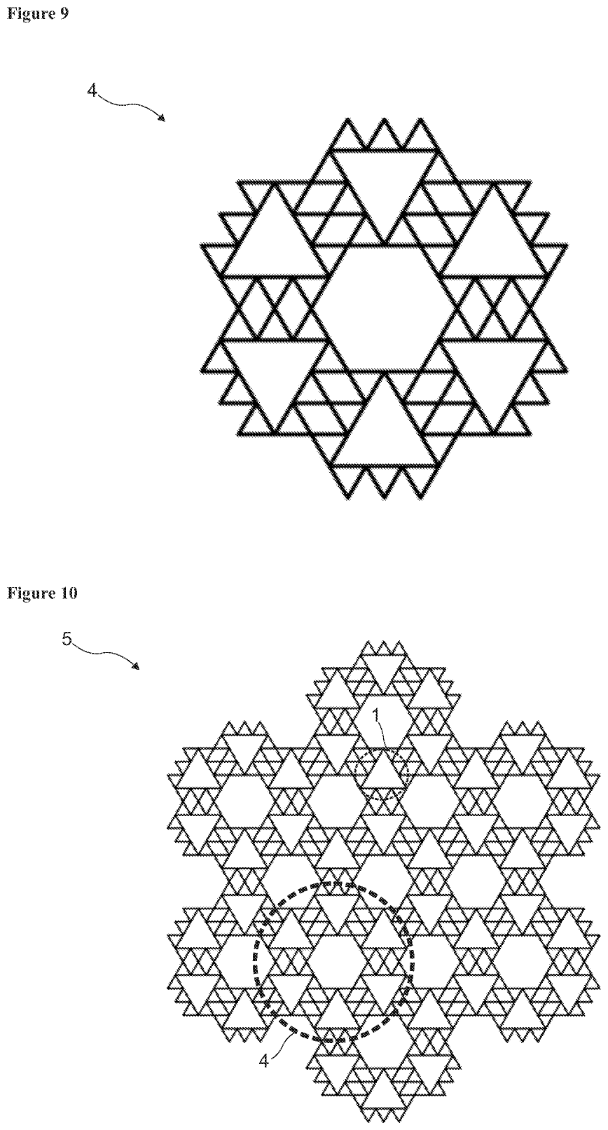

FIG. 10. A view of a part of the “Hierarchical-3 Triangles lattice material” formed by combining “Hierarchical-3 Triangles unit cells”.

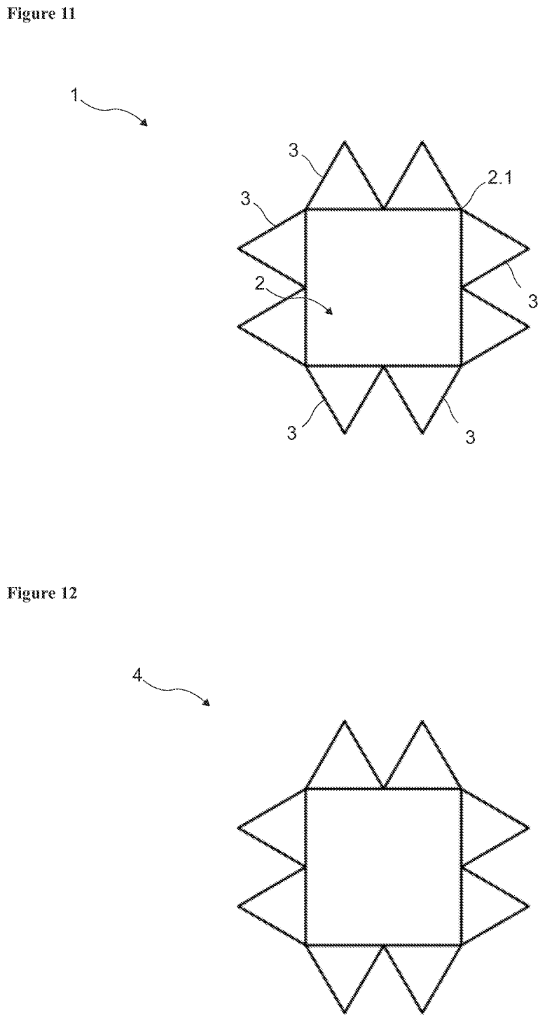

FIG. 11. A view of the “Mixed Quadrilateral-2 Triangles truss structure”, which consists of a quadrilateral inner element and outer struts forming two triangles on each edge of the inner element.

FIG. 12. A view of the “Mixed Quadrilateral-2 Triangles unit cell,” which consists of a single “Mixed Quadrilateral-2 Triangles truss structure”.

FIG. 13. A view of a part of the “Mixed Quadrilateral-2 Triangles lattice material” formed by combining “Mixed Quadrilateral-2 Triangles unit cells”.

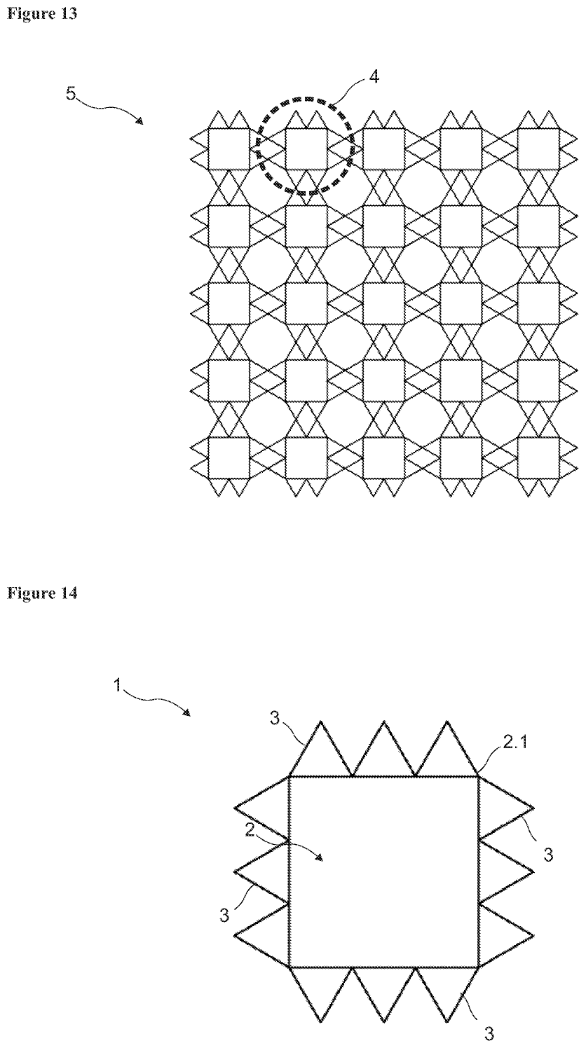

FIG. 14. A view of the “Mixed Quadrilateral-3 Triangles truss structure”, which consists of a quadrilateral inner element and outer struts forming three triangles on each edge of the inner element.

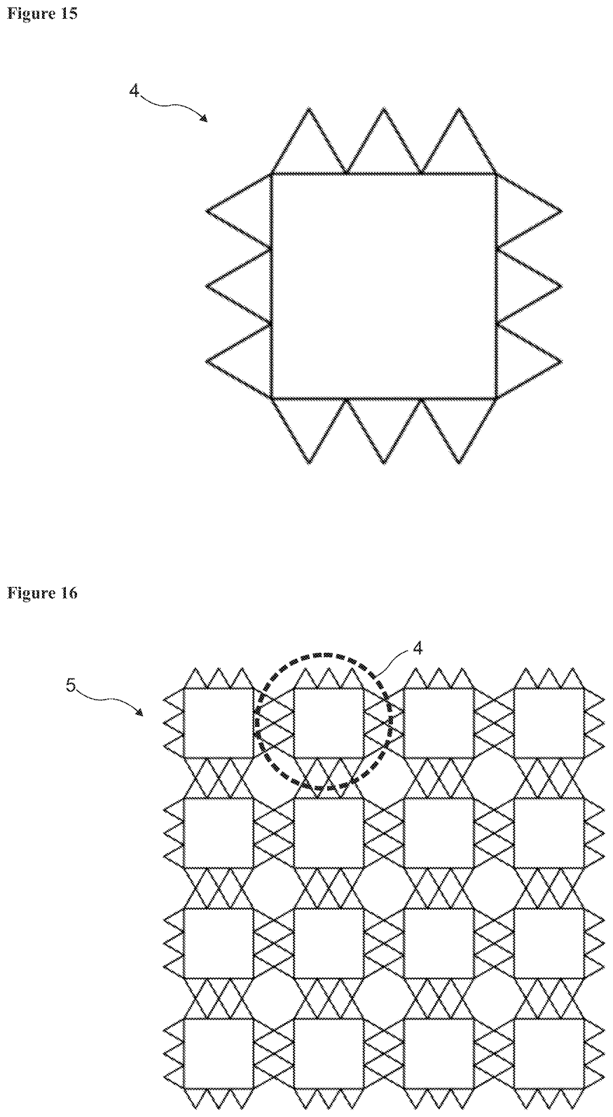

FIG. 15. A view of the “Mixed Quadrilateral-3 Triangles unit cell,” which consists of a single “Mixed Quadrilateral-3 Triangles truss structure”.

FIG. 16. A view of a part of the “Mixed Quadrilateral-3 Triangles lattice material” formed by combining “Mixed Quadrilateral-3 Triangles unit cells”.

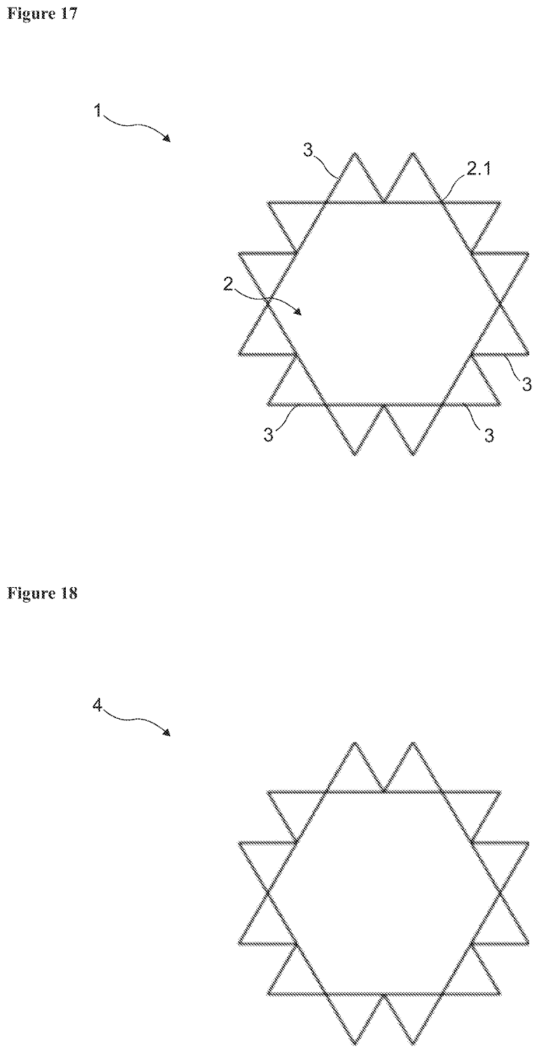

FIG. 17. A view of the “Mixed Hexagonal-2 Triangles truss structure”, which consists of a hexagonal inner element and outer struts forming two triangles on each edge of the inner element.

FIG. 18. A view of the “Mixed Hexagonal-2 Triangles unit cell,” which consists of a single “Mixed Hexagonal-2 Triangles truss structure”.

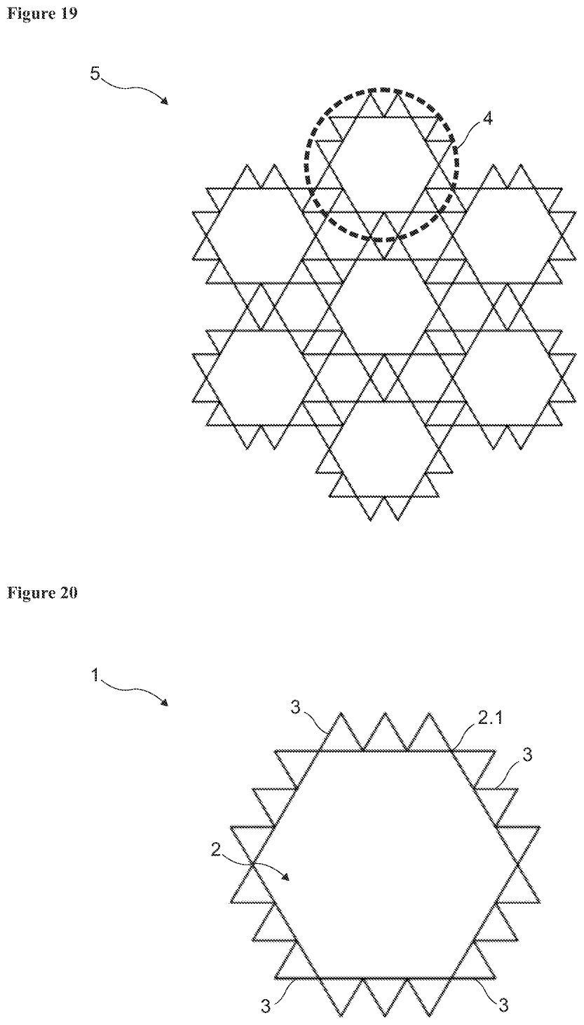

FIG. 19. A view of a part of the “Mixed Hexagonal-2 Triangles lattice material” formed by combining “Mixed Hexagonal-2 Triangles unit cells”.

FIG. 20. A view of the “Mixed Hexagonal-3 Triangles truss structure”, which consists of a hexagonal inner element and outer struts forming three triangles on each edge of the inner element.

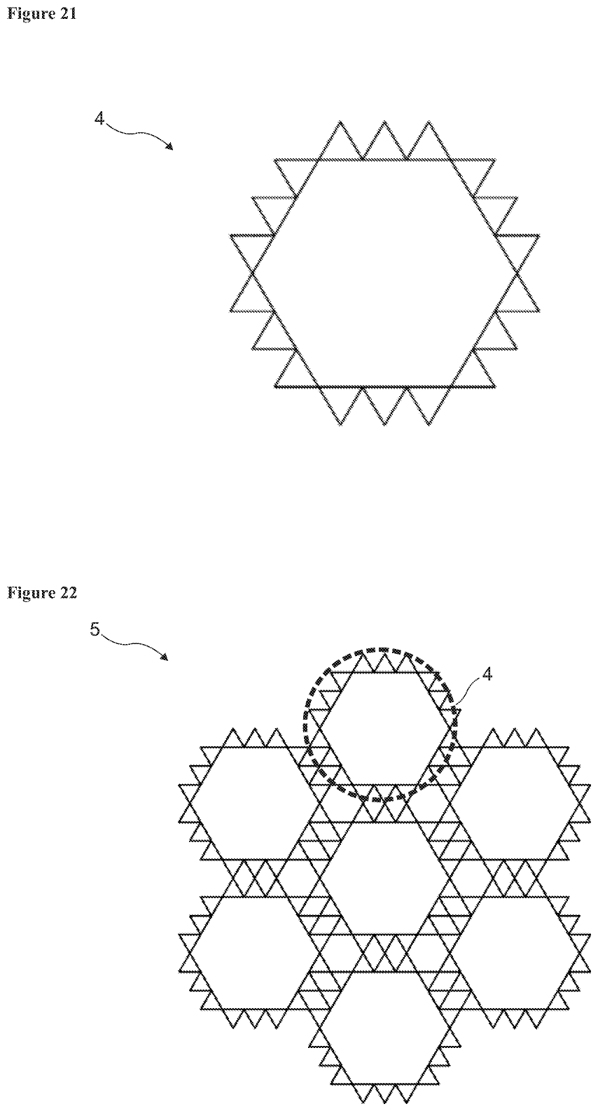

FIG. 21. A view of the “Mixed Hexagonal-3 Triangles unit cell,” which consists of a single “Mixed Hexagonal-3 Triangles truss structure”.

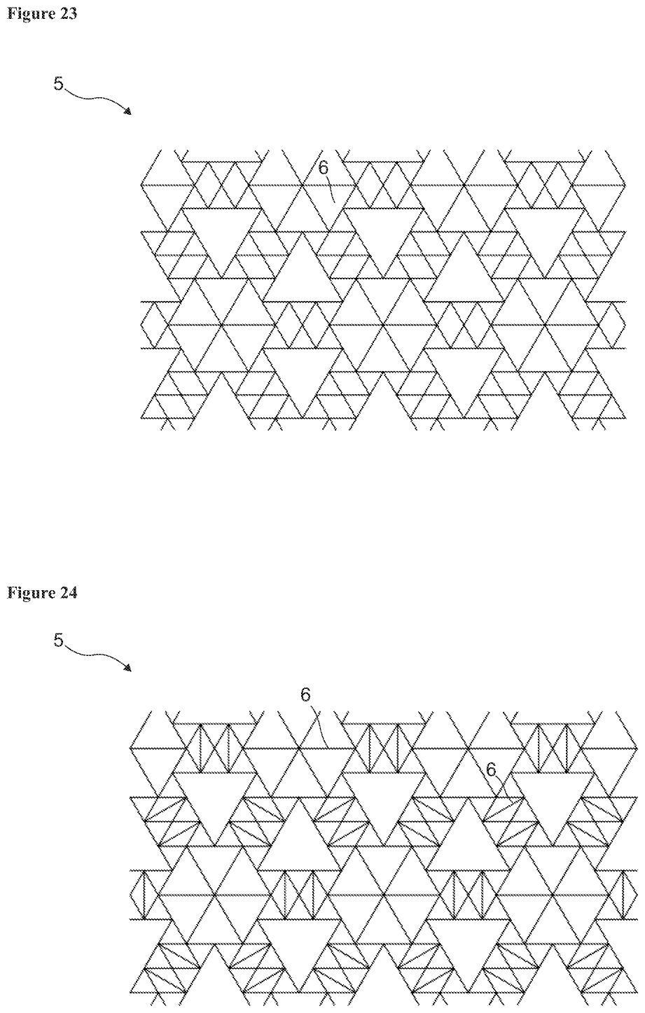

FIG. 22. A view of a part of the “Mixed Hexagonal-3 Triangles lattice material” formed by combining “Mixed Hexagonal-3 Triangles unit cells”.

FIG. 23. A view of a part of “Hierarchical-3-Y1 Triangles lattice material” created by adding six auxiliary struts to each hollow hexagonal region of the “Hierarchical-3 Triangles lattice material”, which is composed of “Hierarchical-3 Triangles unit cells”.

FIG. 24. A view of a part of “Hierarchical-3-Y2 Triangles lattice material” created by adding six auxiliary struts to each hollow hexagonal region and one auxiliary strut to each hollow quadrilateral region surrounded by the outer struts (so that the auxiliary strut would be perpendicular to the inner element edges of the truss structure) of the “Hierarchical-3 Triangles lattice material”, which is composed of “Hierarchical-3 Triangles unit cells”.

FIG. 25. A view of a part of “Hierarchical-3-Y3 Triangles lattice material” created by adding six auxiliary struts to each hollow hexagonal region and one auxiliary strut to each hollow quadrilateral region surrounded by the outer struts (so that the auxiliary strut would be parallel to the inner element edges of the truss structure) of the “Hierarchical-3 Triangles lattice material”, which is composed of “Hierarchical-3 Triangles unit cells”.

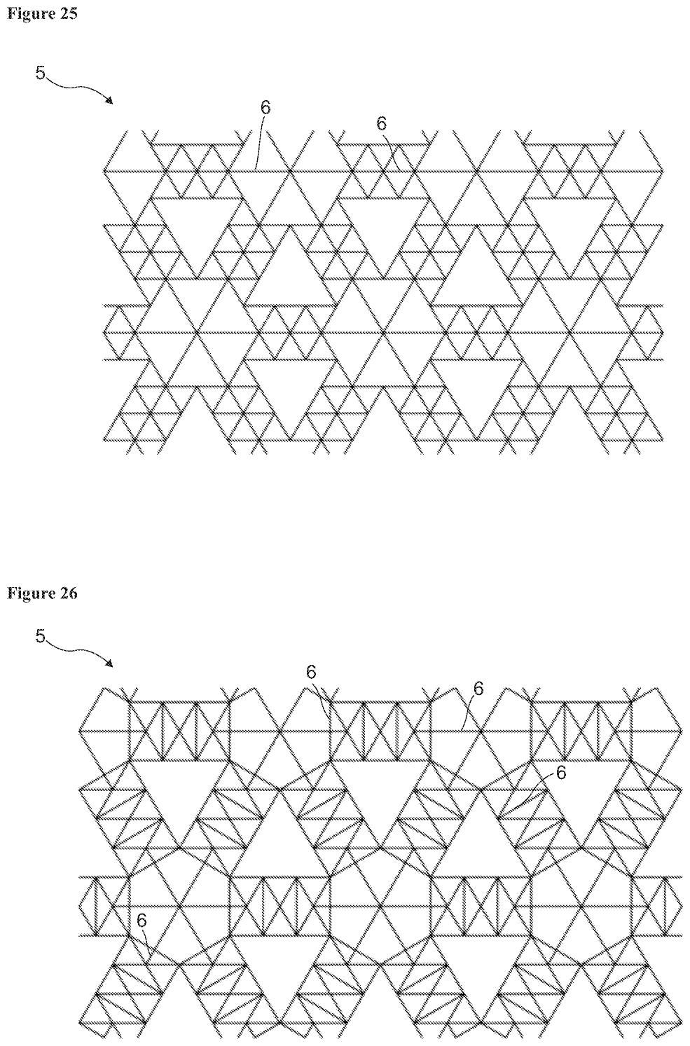

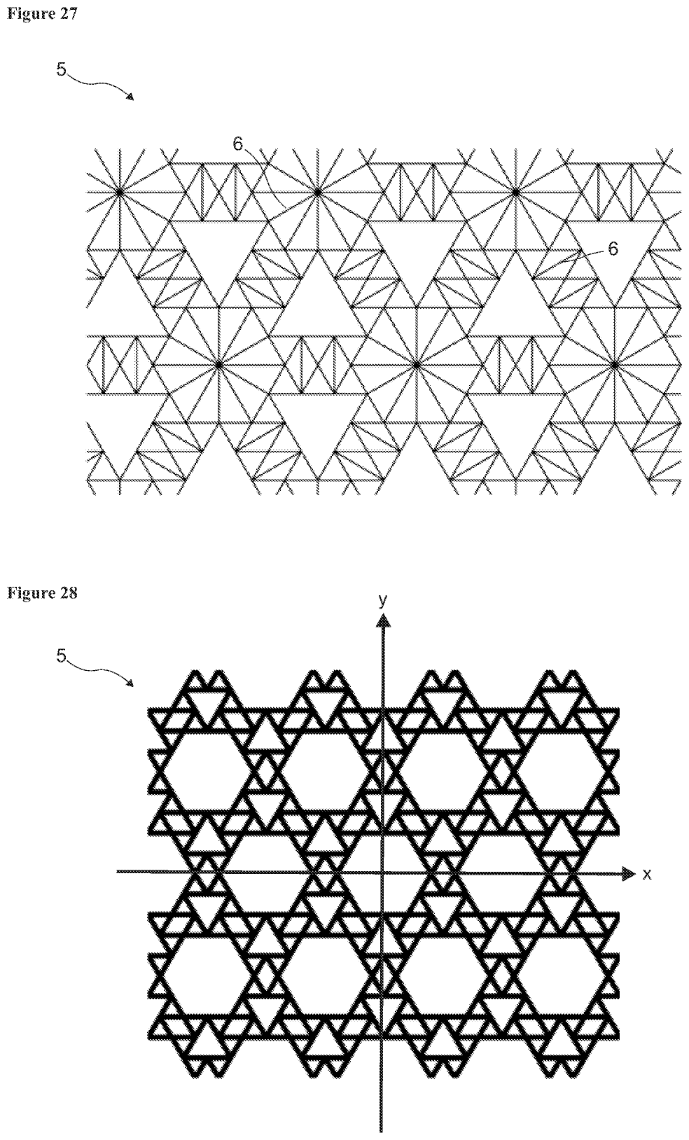

FIG. 26. A view of a part of “Hierarchical-3-Y4 Triangles lattice material” created by adding twenty-four auxiliary struts to each hollow hexagonal region and one auxiliary strut to each hollow quadrilateral region surrounded by the outer struts (so that the auxiliary strut would be perpendicular to the inner element edges of the truss structure) of the “Hierarchical-3 Triangles lattice material”, which is composed of “Hierarchical-3 Triangles unit cells”.

FIG. 27. A view of a part of “Hierarchical-3-Y5 Triangles lattice material” created by adding twelve auxiliary struts to each hollow hexagonal region and one auxiliary strut to each hollow quadrilateral region surrounded by the outer struts (so that the auxiliary strut would be perpendicular to the inner element edges of the truss structure) of the “Hierarchical-3 Triangles lattice material”, which is composed of “Hierarchical-3 Triangles unit cells”.

FIG. 28. A different view of a part of the “Hierarchical-2 Triangles lattice material” formed by combining “Hierarchical-2 Triangles unit cells”.

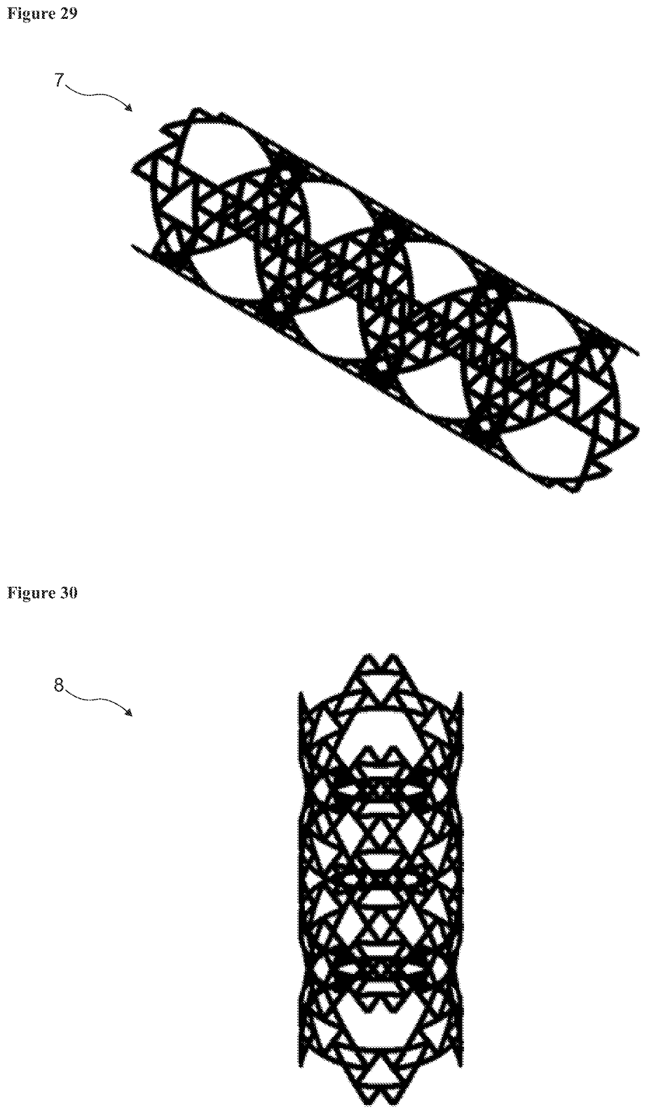

FIG. 29. A view of a circular cylindrical tube obtained by folding a piece of the “Hierarchical-2 Triangles lattice material” formed by combining “Hierarchical-2 Triangles unit cells” around the x-axis.

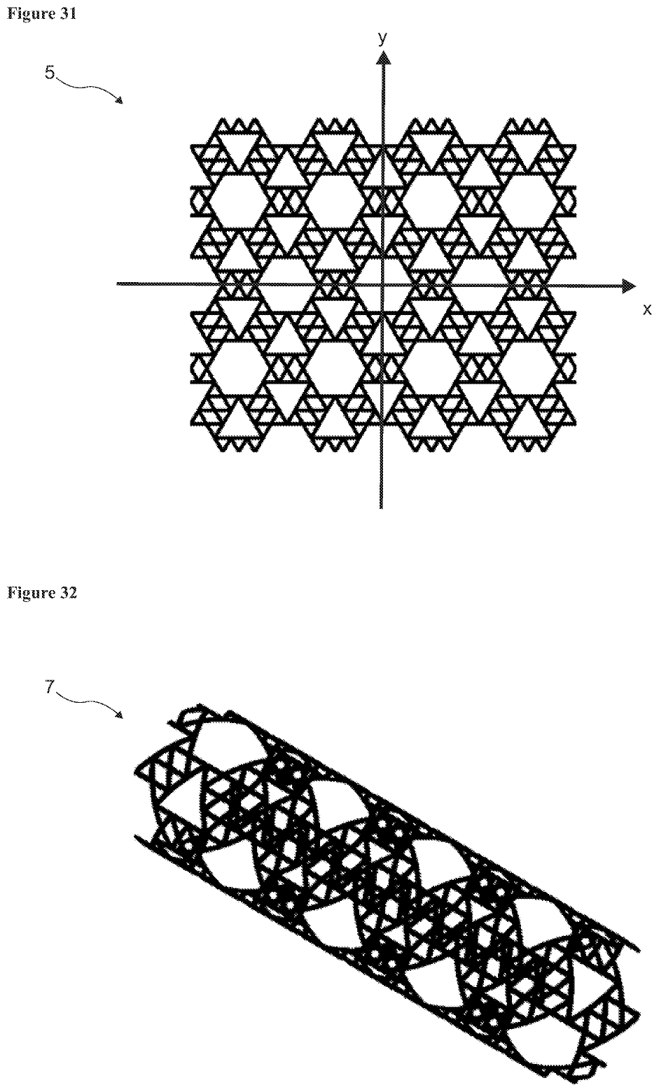

FIG. 30. A view of a circular cylindrical tube obtained by folding a piece of the “Hierarchical-2 Triangles lattice material” formed by combining “Hierarchical-2 Triangles unit cells” around the y-axis.

FIG. 31. A different view of a part of the “Hierarchical-3 Triangles lattice material” formed by combining “Hierarchical-3 Triangles unit cells”.

FIG. 32. A view of a circular cylindrical tube obtained by folding a piece of the “Hierarchical-3 Triangles lattice material” formed by combining “Hierarchical-3 Triangles unit cells” around the x-axis.

FIG. 33. A view of a circular cylindrical tube obtained by folding a piece of the “Hierarchical-3 Triangles lattice material” formed by combining “Hierarchical-3 Triangles unit cells” around the y-axis.

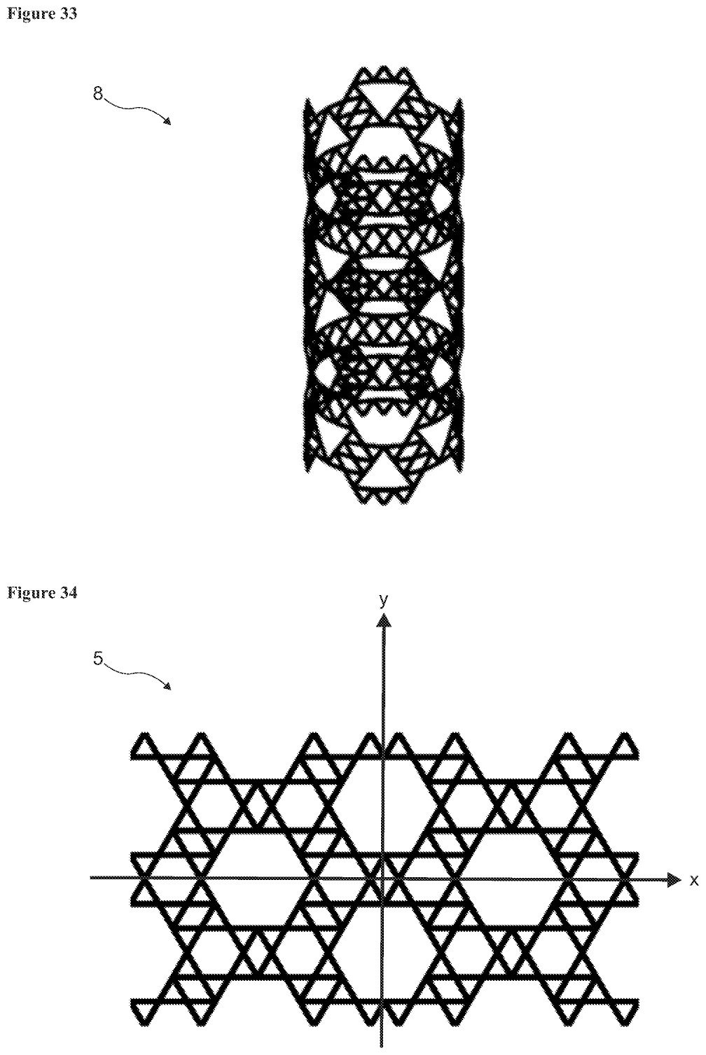

FIG. 34. A different view of a part of the “Mixed Hexagonal-2 Triangles lattice material” formed by combining “Mixed Hexagonal-2 Triangles unit cells”.

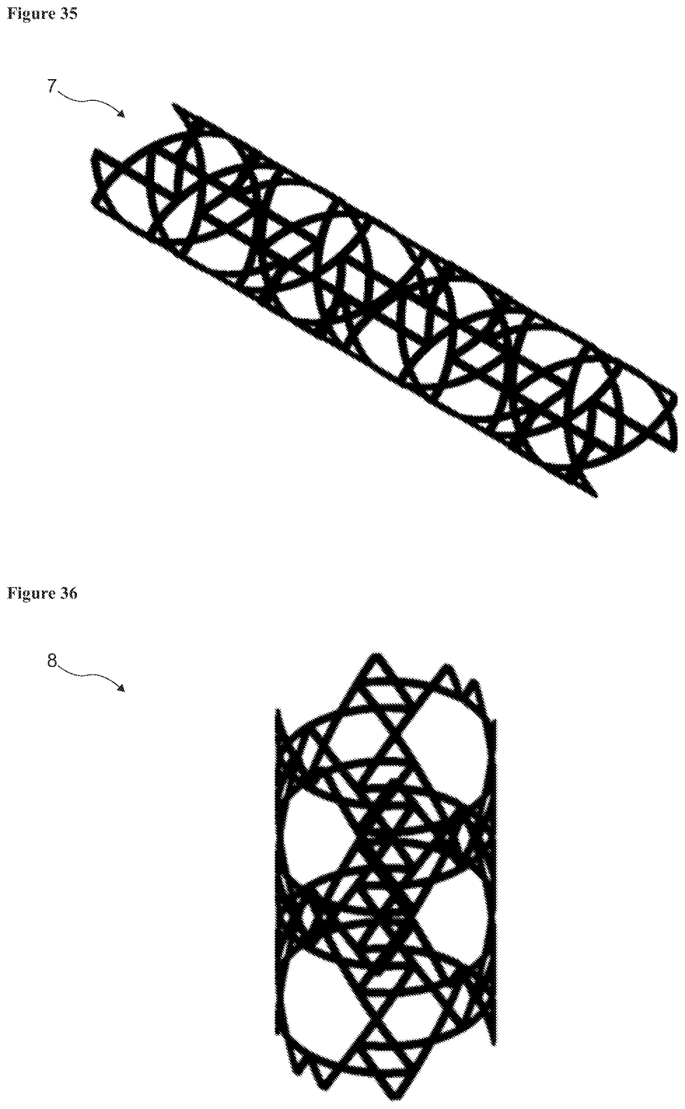

FIG. 35. A view of a circular cylindrical tube obtained by folding a piece of the “Mixed Hexagonal-2 Triangles lattice material” formed by combining “Mixed Hexagonal-2 Triangles unit cells” around the x-axis.

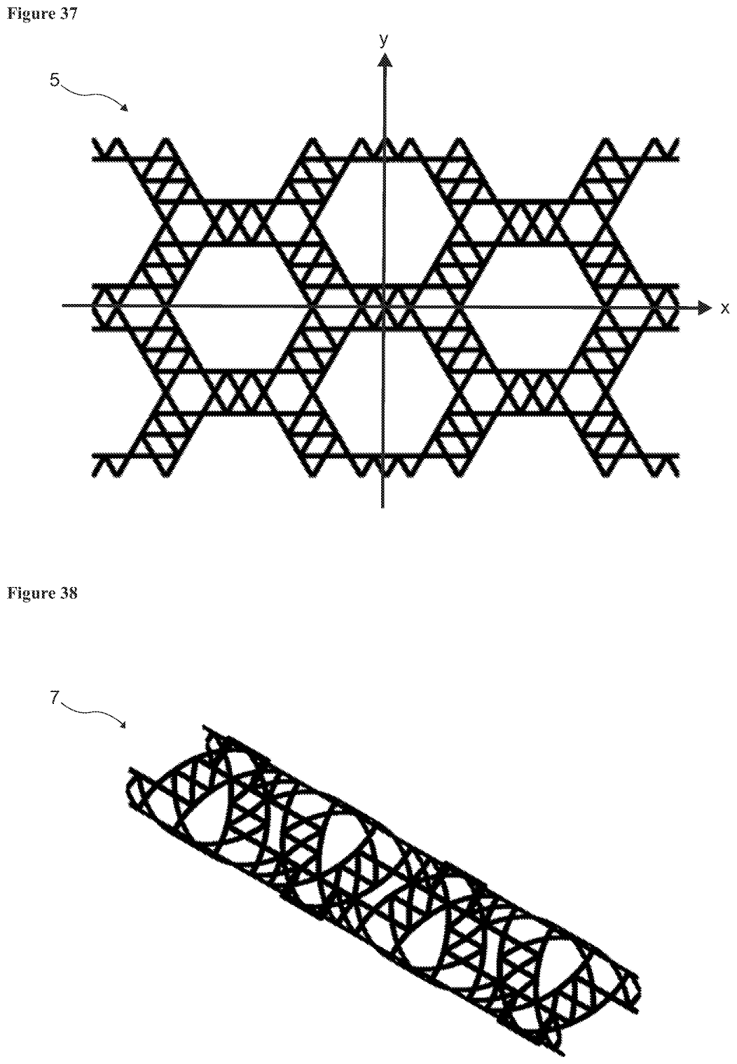

FIG. 36. A view of a circular cylindrical tube obtained by folding a piece of the “Mixed Hexagonal-2 Triangles lattice material” formed by combining “Mixed Hexagonal-2 Triangles unit cells” around the y-axis.

FIG. 37. A different view of a part of the “Mixed Hexagonal-3 Triangles lattice material” formed by combining “Mixed Hexagonal-3 Triangles unit cells”.

FIG. 38. A view of a circular cylindrical tube obtained by folding a piece of the “Mixed Hexagonal-3 Triangles lattice material” formed by combining “Mixed Hexagonal-3 Triangles unit cells” around the x-axis.

FIG. 39. A view of a circular cylindrical tube obtained by folding a piece of the “Mixed Hexagonal-3 Triangles lattice material” formed by combining “Mixed Hexagonal-3 Triangles unit cells” around the y-axis.

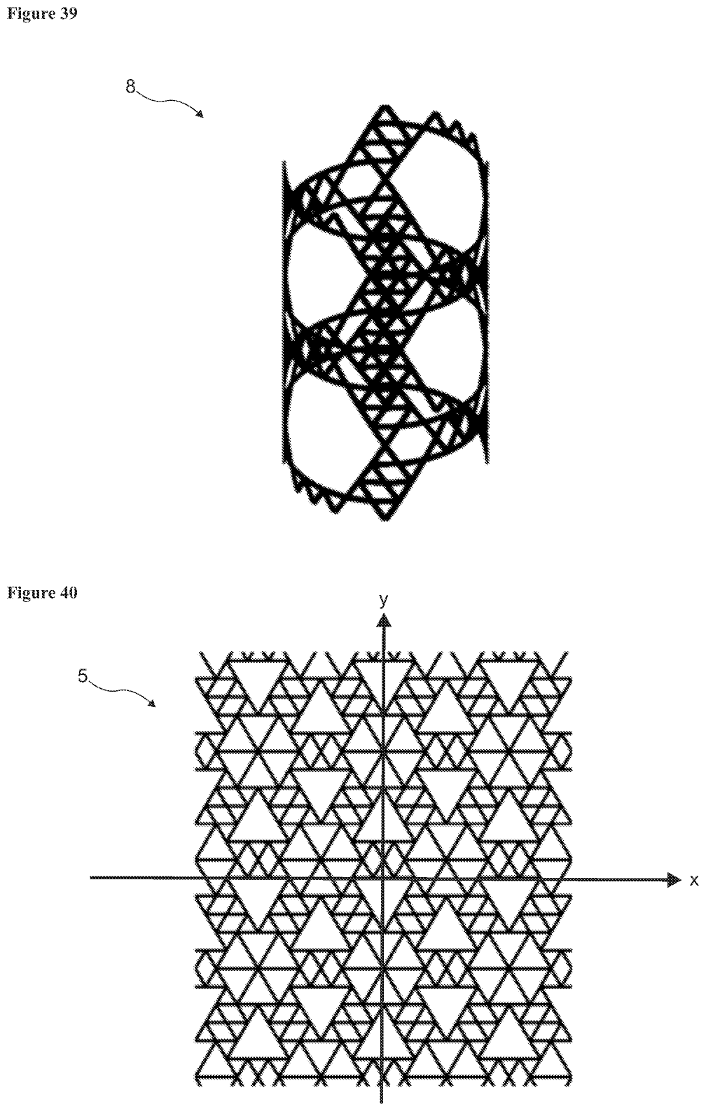

FIG. 40. A different view of a part of “Hierarchical-3-Y1 Triangles lattice material” created by adding six auxiliary struts to each hollow hexagonal region of the “Hierarchical-3 Triangles lattice material”, which is composed of “Hierarchical-3 Triangles unit cells”.

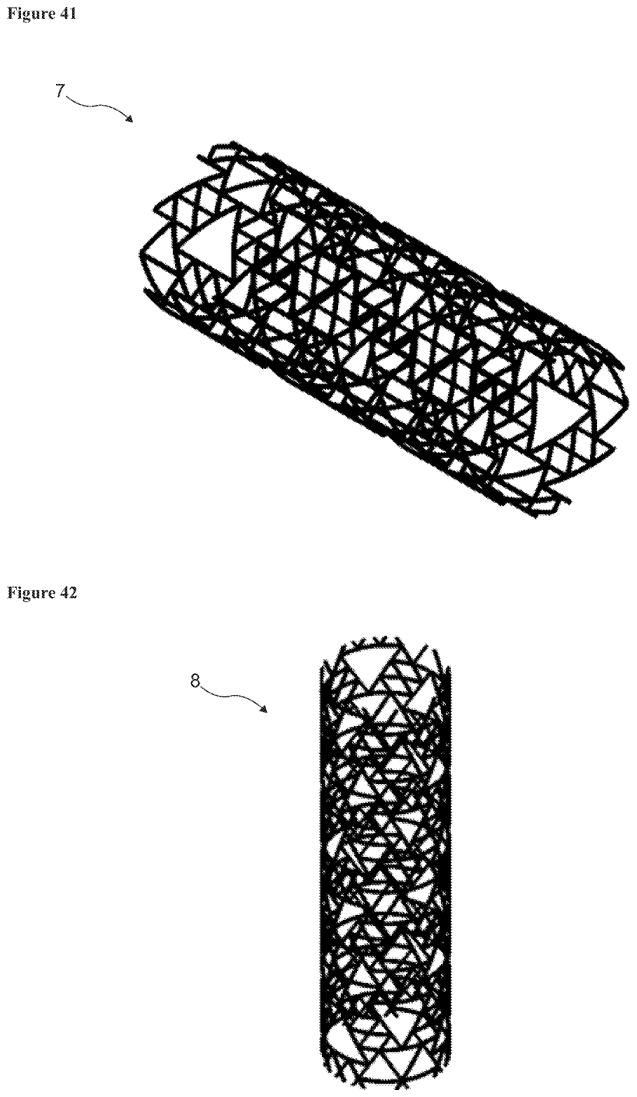

FIG. 41. A view of a circular cylindrical tube obtained by folding a piece of “Hierarchical-3-Y1 Triangles lattice material” around the x-axis. “Hierarchical-3-Y1 Triangles lattice material” is created by adding six auxiliary struts to each hollow hexagonal region of the “Hierarchical-3 Triangles lattice material”, which is composed of “Hierarchical-3 Triangles unit cells”.

FIG. 42. A view of a circular cylindrical tube obtained by folding a piece of “Hierarchical-3-Y1 Triangles lattice material” around the y-axis. “Hierarchical-3-Y1 Triangles lattice material” is created by adding six auxiliary struts to each hollow hexagonal region of the “Hierarchical-3 Triangles lattice material”, which is composed of “Hierarchical-3 Triangles unit cells”.

FIG. 43. A different view of a part of “Hierarchical-3-Y2 Triangles lattice material” created by adding six auxiliary struts to each hollow hexagonal region and one auxiliary strut to each hollow quadrilateral region surrounded by the outer struts (so that the auxiliary strut would be perpendicular to the inner element edges of the truss structure) of the “Hierarchical-3 Triangles lattice material”, which is composed of “Hierarchical-3 Triangles unit cells”.

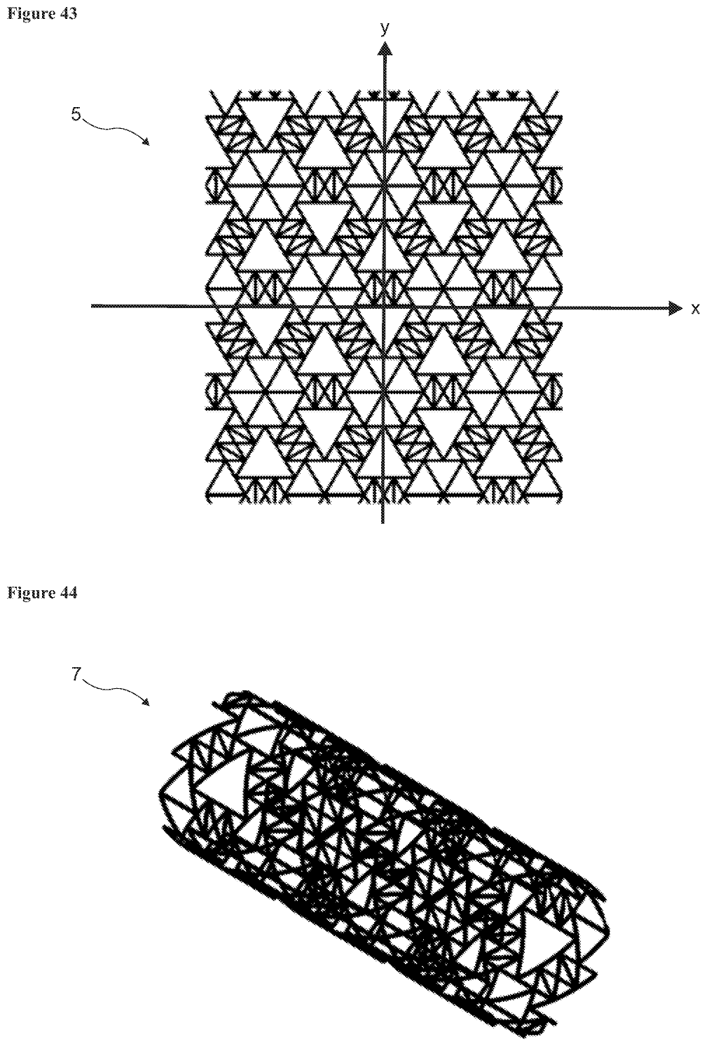

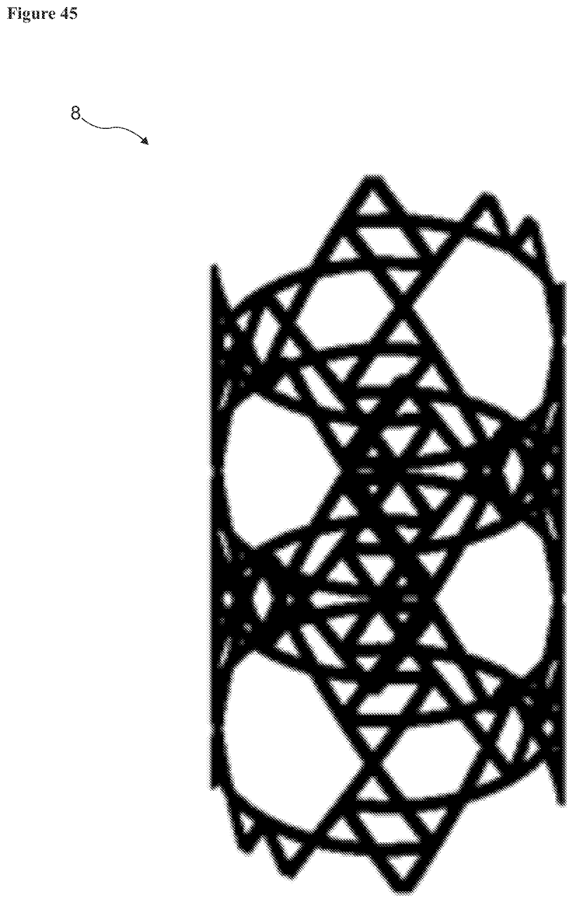

FIG. 44. A view of a circular cylindrical tube obtained by folding a piece of “Hierarchical-3-Y2 Triangles lattice material” around the x-axis. “Hierarchical-3-Y2 Triangles lattice material” created by adding six auxiliary struts to each hollow hexagonal region and one auxiliary strut to each hollow quadrilateral region surrounded by the outer struts (so that the auxiliary strut would be perpendicular to the inner element edges of the truss structure) of the “Hierarchical-3 Triangles lattice material”, which is composed of “Hierarchical-3 Triangles unit cells”.

FIG. 45. A view of a circular cylindrical tube obtained by folding a piece of “Hierarchical-3-Y2 Triangles lattice material” around the y-axis. “Hierarchical-3-Y2 Triangles lattice material” created by adding six auxiliary struts to each hollow hexagonal region and one auxiliary strut to each hollow quadrilateral region surrounded by the outer struts (so that the auxiliary strut would be perpendicular to the inner element edges of the truss structure) of the “Hierarchical-3 Triangles lattice material”, which is composed of “Hierarchical-3 Triangles unit cells”.

The components given in the figures are enumerated individually, and the meanings of the numbers are provided below.
1. Truss structure
2. Truss structure's inner element
2.1. Inner element edge
3. Outer strut
4. Unit cell
5. Two-dimensional (2D) lattice
6. Auxiliary strut
7. First cylindrical tube (obtained by folding the two-dimensional (2D) lattice around the x-axis)
8. Second cylindrical tube (obtained by folding the two-dimensional (2D) lattice around the y-axis)

In its most basic form, a truss structure (1), which forms the basis of lattice materials obtained by tessellating unit cells in the plane and ensures that the elastic modulus values per unit weight of the formed lattice materials are greater than those of many existing cellular solids with stochastic distribution and many existing lattice materials, consists of;
at least one truss structure's inner element (2) in a triangular, quadrilateral, or hexagonal geometric form, comprising at least three inner element edges (2.1) and formed by combining the inner element edges (2.1),
at least twelve outer struts (3) placed on the inner element edges (2.1) of the truss structure's inner element (2),
   placed on the inner element edge (2.1) joined to form at least two triangles, and
   change the mechanical properties of the truss structure (1) as the number of triangles increases.

The unit cell (4) consists of six truss structures (1) if the truss structure's inner element (2) is in a triangular geometric form and of one truss structure (1) if the truss structure's inner element (2) is in a quadrilateral or hexagonal geometric form.

A two-dimensional (2D) lattice (5) of the desired size can be obtained by combining the required number of unit cells (4).

The truss structure (1) may optionally contain auxiliary struts (6) that can be placed in different regions, in different numbers, and in different directions within the truss structure's inner element (2), increasing the resistance of the truss structure (1) to deformation.

The two-dimensional (2D) lattice (5) obtained by joining the unit cells (4) to each other can be folded around an axis in the plane to obtain lattice structures in the form of a first cylindrical tube (7) or a second cylindrical tube (8).

The truss structure (1) at issue in this application is utilized in numerous engineering fields, especially in materials engineering. The truss structure (1) at issue in this application consists of the truss structure's inner element (2) and the outer struts (3). The truss structure (1) at issue in this application is created by placing outer struts (3) on the edges of the inner element of the truss structure, which has the geometric shape of a triangle, quadrilateral, or hexagon, to form at least two triangles on each inner element edge (2.1). The truss structures (1) combine to create the unit cell (4). The unit cell (4) is composed of six truss structures (1) if the truss structure's inner element (2) has the geometric shape of a triangle, and one truss structure (1) if the truss structure's inner element (2) has the geometric shape of a quadrilateral or hexagon. Two-dimensional (2D) lattice materials (5) are obtained by tessellating the unit cells (4) in the plane. In other words, the truss structures (1) compose the unit cells (4), and the unit cells (4) form the lattice materials.

The truss structure (1) ensures that the elastic modulus values per unit weight of the lattice materials formed from it are greater than those of existing cellular solids with stochastic distribution and the vast majority of existing lattice materials. Depending on the geometric form of the truss structure's inner element (2) and the number of triangles placed on the inner element edges (2.1), it is possible to produce lattice materials with in-plane isotropic mechanical properties and high shear elastic and modulus values. Depending on the geometric form of the truss structure's inner element (2) and the number of triangles placed on the inner element edges (2.1), it is possible to produce lattice materials with a negative Poisson's ratio (NPO). The truss structure (1) at issue in this application may optionally include auxiliary struts (6). The auxiliary struts (6) increase the resistance of the truss structure (1) against deformation. The lattice structure (5) formed from the truss structure (1) can be folded around an axis in the plane to obtain lattice structures in the form of a first cylindrical tube (7) or a second cylindrical tube (8). Spherical lattice structures can be created by joining truss structures (1).

In one embodiment of the invention at issue in this application, the truss structure's inner element (2) can be in the geometric form of a triangle, a quadrilateral, or a hexagon. The truss structure's inner element (2) includes the inner element edge (2.1). The truss structure's inner element (2) is formed by combining the inner element edges (2.1).

In one embodiment of the invention at issue in this application, the outer struts (3) are placed on the inner element edges (2.1) of the truss structure's inner element (2). The outer struts (3) are assembled to form at least two triangles on each inner element edge (2.1). As the number of triangles formed by the outer struts (3) increases, the mechanical properties of the lattice material (5) produced from the truss structure (1) change.

The unit cell (4) in one embodiment of the invention at issue in this application is formed by combining truss structures (1). The unit cell (4) consists of six truss structures (1) if the truss structure's inner element (2) has the geometric shape of a triangle, and one truss structure (1) if the truss structure's inner element (2) has the geometric shape of a quadrilateral or hexagon.

In one embodiment of the invention at issue in this application, the two-dimensional (2D) lattice (5) is obtained by combining unit cells (4). By combining truss structures (1), unit cells (4) are produced, and by combining unit cells (4), a two-dimensional (2D) lattice (5) is generated.

In one embodiment of the invention at issue in this application, auxiliary struts (6) may optionally be placed inside the truss structure (1). The auxiliary struts (6) enhance the resistance to deformation of the truss structure (1) in which they are placed.

In one embodiment of the invention at issue in this application, lattice structures in the form of the first cylindrical tube (7) or the second cylindrical tube (8) may be obtained by folding the two-dimensional (2D) lattice (5), which is obtained by joining the unit cells (4), around an axis in the plane. Truss structures (1) can be combined to create spherical lattice structures.

In this embodiment of the invention at issue in this application, the inner element (2) of the truss structure (1) has a triangular shape (FIG. 5 and FIG. 8). As shown in FIG. 5, the inner element (2) of the truss structure (1) is obtained by combining the inner element edges (2.1) of equal length to form a triangle. On each inner element edge (2.1) of the inner element (2) of the truss structure (1), outer struts (3) are assembled into equilateral triangles.

In this embodiment of the invention at issue in this application, the inner element (2) of the truss structure (1) is formed by joining three equal-length inner element edges (2.1), as shown in FIG. 5. On each inner element edge (2.1) of the inner element (2) of the truss structure (1), outer struts (3) are added to create two equal-sized triangles. By adding outer struts (3) to each inner element edge (2.1) of the inner element (2) of the truss structure (1) to form two triangles of equal size, the “Hierarchical-2 Triangles truss structure” is obtained.

In this embodiment of the invention at issue in this application, as shown in FIG. 6, the unit cell (4) named “Hierarchical-2 Triangles” is obtained by adding six truss structures (1) named “Hierarchical-2 Triangles” at the apex of the triangles formed by the outer struts (3).

In this embodiment of the invention at issue in this application, as shown in FIG. 7, a two-dimensional (2D) lattice (5) named “Hierarchical-2 Triangles” is obtained by combining unit cells (4) called “Hierarchical-2 Triangles” at the apex of the triangles formed by the outer struts (3).

In this embodiment of the invention at issue in this application, the inner element (2) of the truss structure (1) is formed by joining three equal-length inner element edges (2.1), as shown in FIG. 8. On each inner element edge (2.1) of the inner element (2) of the truss structure (1), outer struts (3) are added to create three equal-sized triangles. By adding outer struts (3) to each inner element edge (2.1) of the inner element (2) of the truss structure (1) to form three triangles of equal size, the “Hierarchical-3 Triangles truss structure” is obtained.

In this embodiment of the invention at issue in this application, as shown in FIG. 9, the unit cell (4) named “Hierarchical-3 Triangles” is obtained by adding six truss structures (1) called “Hierarchical-3 Triangles” at the apex of the triangles formed by the outer struts (3).

In this embodiment of the invention at issue in this application, as shown in FIG. 10, a two-dimensional (2D) lattice (5) named “Hierarchical-3 Triangles” is obtained by combining unit cells (4) called “Hierarchical-3 Triangles” at the apex of the triangles formed by the outer struts (3).

The two-dimensional (2D) lattice materials (5) composed of truss structures (1) named “Hierarchical-2 Triangles” (FIG. 5) and “Hierarchical-3 Triangles” (FIG. 8) have different mechanical properties. In addition, the two-dimensional (2D) lattice materials (5) composed of the truss structures (1) named “Hierarchical-2 Triangles” (FIG. 5) and “Hierarchical-3 Triangles” (FIG. 8) have transverse isotropic mechanical properties. That is, the in-plane mechanical properties of these materials are isotropic (direction independent). Similar to the “Hierarchical-2 Triangles” and “Hierarchical-3 Triangles” truss structures (1), a truss structure named “Hierarchical-S Triangles” can be created by increasing S, or the number of triangles formed by the outer struts (3) on the inner element edges (2.1), where S is an integer greater than or equal to 2. Two-dimensional (2D) lattice materials (5) composed of “Hierarchical-S Triangles” truss structures (1) have transverse isotropic mechanical properties.

In this embodiment of the invention, the “Hierarchical-S Triangles” lattice materials (where S is the number of triangles formed by outer struts (3)) are analyzed in the range S=2 to S=12 by increasing the number of triangles formed by the outer struts (3) on the inner element edges (2.1). The analyses revealed that the lattice material (5) named “Hierarchical-3 Triangles” exhibits the most stretching-dominated behavior with an exponential n value of 1.05, while the lattice material (5) named “Hierarchical-2 Triangles” exhibits the most bending-dominated behavior with an exponential n value of 2.91 (see Equation 2). Variations in deformation behavior influence mechanical properties. The effects of relative density on the elastic modulus, shear modulus, and Poisson's ratio were studied for lattice materials (5) consisting of “Hierarchical-S Triangles” truss structures (1) with S ranging from 2 to 12. The elastic (E) and shear (G) modulus values of the lattice materials (5) are normalized by dividing the elastic (Eₛ) and shear (Gₛ) modulus values of the solid from which the lattice is fabricated by the product of the lattice's relative density value (ρ*). As determined by this investigation, the “Hierarchical-3 Triangles” lattice material (5) has the highest elastic and shear modulus values among the “Hierarchical-S Triangles” lattice materials (5).

For all S (2≤S≤12) and relative density values (0<ρ*≤0.2) examined in this embodiment of the invention, the Poisson's ratio of the “Hierarchical-S Triangle” lattice materials (5) increases as the relative density increases. Poisson's ratios are negative in all relative density values studied for S≤6. For S>7, the Poisson ratio, which is negative at low relative density values, reaches positive values as the relative density value increases.

In one embodiment of the invention, when determining the mechanical properties of the lattice materials (5) formed by the truss structure (1) “Hierarchical-S Triangles”, it is assumed that all the struts forming the truss structure (1) are made from the same solid (i.e., they have the same mechanical properties) and have the same geometric properties. To modify the mechanical properties of the lattice material to meet different design specifications, it is also possible to produce lattices with struts that have different material and/or geometric properties.

In this embodiment of the invention, the truss structure's inner element (2) has a quadrilateral shape (FIG. 11 and FIG. 14). As shown in FIG. 11, the truss structure's inner element (2) is obtained by joining the equal-length inner element edges (2.1) into a quadrilateral. Outer struts (3) are added to each inner element edge (2.1) of the truss structure's inner element (2) to form equilateral triangles.

In this embodiment of the invention, as shown in FIG. 11, the truss structure's inner element (2) is obtained by joining the equal-length inner element edges (2.1) into a quadrilateral. Outer struts (3) are placed on each inner element edge (2.1) of the truss structure's inner element (2) to form two equilateral triangles. By placing outer struts (3) to form two equilateral triangles on each inner element edge (2.1) of the truss structure's inner element (2), the truss structure (1) named “Mixed Quadrilateral-2 Triangles” is obtained.

In this embodiment of the invention, as depicted in FIG. 12, a truss structure (1) named “Mixed Quadrilateral-2 Triangles” corresponds to a unit cell (4) also named “Mixed Quadrilateral-2 Triangles”.

In this embodiment of the invention, as depicted in FIG. 13, a two-dimensional (2D) lattice (5) named “Mixed Quadrilateral-2 Triangles” is obtained by joining the unit cells (4) named “Mixed Quadrilateral-2 Triangles” at the apex of the triangles formed by the outer struts (3).

In this embodiment of the invention, as shown in FIG. 14, the truss structure's inner element (2) is obtained by joining the equal-length inner element edges (2.1) into a quadrilateral. Outer struts (3) are placed on each inner element edge (2.1) of the truss structure's inner element (2) to form three equilateral triangles. By placing outer struts (3) to form three equilateral triangles on each inner element edge (2.1) of the truss structure's inner element (2), the truss structure (1) named “Mixed Quadrilateral-3 Triangles” is obtained.

In this embodiment of the invention, as depicted in FIG. 15, a truss structure (1) named “Mixed Quadrilateral-3 Triangles” corresponds to a unit cell (4) also named “Mixed Quadrilateral-3 Triangles”.

In this embodiment of the invention, as depicted in FIG. 16, a two-dimensional (2D) lattice (5) named “Mixed Quadrilateral-3 Triangles” is obtained by joining the unit cells (4) named “Mixed Quadrilateral-3 Triangles” at the apex of the triangles formed by the outer struts (3).

The two-dimensional (2D) lattice materials (5) composed of truss structures (1) named “Mixed Quadrilateral-2 Triangles” (FIG. 11) and “Mixed Quadrilateral-3 Triangles” (FIG. 14) have different mechanical properties. Similar to the “Mixed Quadrilateral-2 Triangles” and “Mixed Quadrilateral-3 Triangles” truss structures (1), a truss structure named “Mixed Quadrilateral-S Triangles” can be created by increasing S, or the number of triangles formed by the outer struts (3) on the inner element edges (2.1), where S is an integer greater than or equal to 2.

In one embodiment of the invention, when considering the lattice materials (5) formed by the truss structure (1) “Mixed Quadrilateral-S Triangles”, it is assumed that all the struts forming the truss structure (1) are made from the same solid (i.e., they have the same mechanical properties) and have the same geometric properties. To modify the mechanical properties of the lattice material to meet different design specifications, it is also possible to produce lattices with struts that have different material and/or geometric properties.

In this embodiment of the invention, the truss structure's inner element (2) has a hexagonal shape (FIG. 17 and FIG. 20). As shown in FIG. 17, the truss structure's inner element (2) is obtained by joining the equal-length inner element edges (2.1) into a hexagon. Outer struts (3) are added to each inner element edge (2.1) of the truss structure's inner element (2) to form equilateral triangles.

In this embodiment of the invention, as shown in FIG. 17, the truss structure's inner element (2) is obtained by joining the equal-length inner element edges (2.1) into a hexagon. Outer struts (3) are placed on each inner element edge (2.1) of the truss structure's inner element (2) to form two equilateral triangles. By placing outer struts (3) to form two equilateral triangles on each inner element edge (2.1) of the truss structure's inner element (2), the truss structure (1) named “Mixed Hexagonal-2 Triangles” is obtained.

In this embodiment of the invention, as depicted in FIG. 18, a truss structure (1) named “Mixed Hexagonal-2 Triangles” corresponds to a unit cell (4) also named “Mixed Hexagonal-2 Triangles”.

In this embodiment of the invention, as depicted in FIG. 19, a two-dimensional (2D) lattice (5) named “Mixed Hexagonal-2 Triangles” is obtained by joining the unit cells (4) named “Mixed Hexagonal-2 Triangles” at the apex of the triangles formed by the outer struts (3).

In this embodiment of the invention, as shown in FIG. 20, the truss structure's inner element (2) is obtained by joining the equal-length inner element edges (2.1) into a hexagon. Outer struts (3) are placed on each inner element edge (2.1) of the truss structure's inner element (2) to form three equilateral triangles. By placing outer struts (3) to form three equilateral triangles on each inner element edge (2.1) of the truss structure's inner element (2), the truss structure (1) named “Mixed Hexagonal-3 Triangles” is obtained.

In this embodiment of the invention, as depicted in FIG. 21, a truss structure (1) named “Mixed Hexagonal-3 Triangles” corresponds to a unit cell (4) also named “Mixed Hexagonal-3 Triangles”.

In this embodiment of the invention, as depicted in FIG. 22, a two-dimensional (2D) lattice (5) named “Mixed Hexagonal-3 Triangles” is obtained by joining the unit cells (4) named “Mixed Hexagonal-3 Triangles” at the apex of the triangles formed by the outer struts (3).

The two-dimensional (2D) lattice materials (5) composed of truss structures (1) named “Mixed Hexagonal-2 Triangles” (FIG. 17) and “Mixed Hexagonal-3 Triangles” (FIG. 20) have different mechanical properties. In addition, the two-dimensional (2D) lattice materials (5) composed of the truss structures (1) named “Mixed Hexagonal-2 Triangles” (FIG. 17) and “Mixed Hexagonal-3 Triangles” (FIG. 20) have transverse isotropic mechanical properties. That is, the in-plane mechanical properties of these materials are isotropic (direction independent). Similar to the “Mixed Hexagonal-2 Triangles” and “Mixed Hexagonal-3 Triangles” truss structures (1), a truss structure named “Mixed Hexagonal-S Triangles” can be created by increasing S, or the number of triangles formed by the outer struts (3) on the inner element edges (2.1), where S is an integer greater than or equal to 2.

In one embodiment of the invention, when determining the mechanical properties of the lattice materials (5) formed by the truss structure (1) “Mixed Hexagonal-S Triangles”, it is assumed that all the struts forming the truss structure (1) are made from the same solid (i.e., they have the same mechanical properties) and have the same geometric properties. To modify the mechanical properties of the lattice material to meet different design specifications, it is also possible to produce lattices with struts that have different material and/or geometric properties.

In one embodiment of the invention, auxiliary struts (6) are added to the truss structure's inner element (2) to increase the resistance of the truss structure (1) against deformation. Consequently, the mechanical properties of the lattice material (5) consisting of the truss structure (1) can be improved. In this embodiment of the invention, the truss structure (1) formed by adding auxiliary struts (6) to the truss structure's inner element (2) is named “Hierarchical-3-YX Triangles” (X={1, 2, 3, 4, 5}; X depends on the number and direction of auxiliary struts (6) and the region where the auxiliary struts (6) are placed). For a lattice material (5) reinforced by auxiliary struts (6) to have in-plane isotropic mechanical properties, the addition of auxiliary struts (6) must not disturb the six-fold rotational symmetry of the unit cell (4).

In this embodiment of the invention, as shown in FIG. 23, a two-dimensional (2D) lattice (5) named “Hierarchical-3-Y1 Triangles” is obtained by adding six auxiliary struts (6) to each hollow hexagonal region in the two-dimensional (2D) lattice (5) named “Hierarchical-3 Triangles”

In this embodiment of the invention, as shown in FIG. 24, a two-dimensional (2D) lattice (5) named “Hierarchical-3-Y2 Triangles” is obtained by adding six auxiliary struts (6) to each hollow hexagonal region and one auxiliary strut (6) to each hollow quadrilateral region surrounded by the outer struts (3) (so that the auxiliary strut would be perpendicular to the inner element edges (2.1) of the truss structure (1)) of the two-dimensional (2D) lattice (5) named “Hierarchical-3 Triangles”.

In this embodiment of the invention, as shown in FIG. 25, a two-dimensional (2D) lattice (5) named “Hierarchical-3-Y3 Triangles” is obtained by adding six auxiliary struts (6) to each hollow hexagonal region and one auxiliary strut (6) to each hollow quadrilateral region surrounded by the outer struts (3) (so that the auxiliary strut would be parallel to the inner element edges (2.1) of the truss structure (1)) of the two-dimensional (2D) lattice (5) named “Hierarchical-3 Triangles”.

In this embodiment of the invention, as shown in FIG. 26, a two-dimensional (2D) lattice (5) named “Hierarchical-3-Y4 Triangles” is obtained by adding twenty-four auxiliary struts (6) to each hollow hexagonal region and one auxiliary strut (6) to each hollow quadrilateral region surrounded by the outer struts (3) (so that the auxiliary strut would be perpendicular to the inner element edges (2.1) of the truss structure (1)) of the two-dimensional (2D) lattice (5) named “Hierarchical-3 Triangles”.

In this embodiment of the invention, as shown in FIG. 27, a two-dimensional (2D) lattice (5) named “Hierarchical-3-Y5 Triangles” is obtained by adding twelve auxiliary struts (6) to each hollow hexagonal region and one auxiliary strut (6) to each hollow quadrilateral region surrounded by the outer struts (3) (so that the auxiliary strut would be perpendicular to the inner element edges (2.1) of the truss structure (1)) of the two-dimensional (2D) lattice (5) named “Hierarchical-3 Triangles”.

All of the five different two-dimensional (2D) lattice materials (5) named “Hierarchical-3-Y1 Triangles”, “Hierarchical-3-Y2 Triangles”, “Hierarchical-3-Y3 Triangles”, “Hierarchical-3-Y4 Triangles” and “Hierarchical-3-Y5 Triangles” obtained by adding auxiliary struts (6) to the two-dimensional (2D) lattice material (5) named “Hierarchical-3 Triangles” have in-plane isotropic mechanical properties. Poisson's ratio is positive for the two-dimensional (2D) lattice materials (5) named “Hierarchical-3-Y3 Triangles”, “Hierarchical-3-Y4 Triangles”, and “Hierarchical-3-5 Triangles”, whereas it is negative for the two-dimensional (2D) lattice materials (5) named “Hierarchical-3-Y1 Triangles” and “Hierarchical-3-2 Triangles”.

In one embodiment of the invention, while the elastic and shear modulus values of both lattice materials (5) named “Hierarchical-3-Y1 Triangles” and “Hierarchical-3-Y2 Triangles” are larger than that of the lattice material named “Hierarchical-3 Triangles” (5), the lattice material (5) named “Hierarchical-3-Y2 Triangles” has the largest elastic modulus.

In one embodiment of the invention, spherical lattice structures can be created by joining the truss structures (1). In another embodiment of the invention, lattice materials (5), which are produced from the truss structure (1) and have a broad range of mechanical properties, can be folded along any axis in the plane to obtain lattice structures in the form of cylindrical tubes.

In this embodiment of the invention, a lattice structure in the form of a first cylindrical tube (7) is obtained by folding the two-dimensional (2D) lattice (5), named “Hierarchical-2 Triangles” and shown in FIG. 28, around the x-axis (FIG. 29).

In this embodiment of the invention, a lattice structure in the form of a second cylindrical tube (8) is obtained by folding the two-dimensional (2D) lattice (5), named “Hierarchical-2 Triangles” and shown in FIG. 28, around the y-axis (FIG. 30).

In this embodiment of the invention, a lattice structure in the form of a first cylindrical tube (7) is obtained by folding the two-dimensional (2D) lattice (5), named “Hierarchical-3 Triangles” and shown in FIG. 31, around the x-axis (FIG. 32).

In this embodiment of the invention, a lattice structure in the form of a second cylindrical tube (8) is obtained by folding the two-dimensional (2D) lattice (5), named “Hierarchical-3 Triangles” and shown in FIG. 31, around the y-axis (FIG. 33).

In this embodiment of the invention, a lattice structure in the form of a first cylindrical tube (7) is obtained by folding the two-dimensional (2D) lattice (5), named “Mixed Hexagonal-2 Triangles” and shown in FIG. 34, around the x-axis (FIG. 35).

In this embodiment of the invention, a lattice structure in the form of a second cylindrical tube (8) is obtained by folding the two-dimensional (2D) lattice (5), named “Mixed Hexagonal-2 Triangles” and shown in FIG. 34, around the y-axis (FIG. 36).

In this embodiment of the invention, a lattice structure in the form of a first cylindrical tube (7) is obtained by folding the two-dimensional (2D) lattice (5), named “Mixed Hexagonal-3 Triangles” and shown in FIG. 37, around the x-axis (FIG. 38).

In this embodiment of the invention, a lattice structure in the form of a second cylindrical tube (8) is obtained by folding the two-dimensional (2D) lattice (5), named “Mixed Hexagonal-3 Triangles” and shown in FIG. 37, around the y-axis (FIG. 39).

In this embodiment of the invention, a lattice structure in the form of a first cylindrical tube (7) is obtained by folding the two-dimensional (2D) lattice (5), named “Hierarchical-3-Y1 Triangles” and shown in FIG. 40, around the x-axis (FIG. 41).

In this embodiment of the invention, a lattice structure in the form of a second cylindrical tube (8) is obtained by folding the two-dimensional (2D) lattice (5), named “Hierarchical-3-Y1 Triangles” and shown in FIG. 40, around the y-axis (FIG. 42).

In this embodiment of the invention, a lattice structure in the form of a first cylindrical tube (7) is obtained by folding the two-dimensional (2D) lattice (5), named “Hierarchical-3-Y2 Triangles” and shown in FIG. 43, around the x-axis (FIG. 44).

In this embodiment of the invention, a lattice structure in the form of a second cylindrical tube (8) is obtained by folding the two-dimensional (2D) lattice (5), named “Hierarchical-3-Y2 Triangles” and shown in FIG. 43, around the y-axis (FIG. 45).

1. A truss structure which forms the basis of lattice materials obtained by tessellating unit cells in the plane and ensures that the elastic modulus values per unit weight of the formed lattice materials are greater than those of many existing cellular solids with stochastic distribution and many existing lattice materials, the truss structure comprising:
at least one truss structure's inner element in a triangular, quadrilateral, or hexagonal geometric form, comprising at least three inner element edges and formed by combining the inner element edges;
at least twelve outer struts placed on the inner element edges of the truss structure's inner element;
placed on the inner element edge joined to form at least two triangles, and
change the mechanical properties of the truss structure as the number of triangles increases;
the truss structure's inner element obtained by joining equal-length inner element edges to form a triangle;
the truss structure's inner element obtained by joining equal-length inner element edges to form a quadrilateral; or
the truss structure's inner element obtained by joining equal-length inner element edges to form a hexagonal; and
the outer struts added on each inner element edge of the truss structure's inner element to form an equilateral triangle.

2. (canceled)

3. (canceled)

4. The truss structure according to claim 1, wherein the outer struts are added on each inner element edge of the truss structure's inner element to form two equal-sized triangles.

5. The truss structure according to claim 1, wherein the truss structure's inner element provides the truss structure named “Hierarchical-2 Triangles” by adding outer struts on each inner element edge to form two triangles of equal size.

6. The truss structure according to claim 1, wherein the outer struts are added on each inner element edge of the truss structure's inner element to form three equal-sized triangles.

7. The truss structure according to claim 1, wherein the truss structure's inner element provides the truss structure named “Hierarchical-3 Triangles” by adding outer struts on each inner element edge to form three triangles of equal size.

8. (canceled)

9. (canceled)

10. The truss structure according to claim 1, wherein the outer struts are added on each inner element edge of the truss structure's inner element to form two equal-sized triangles.

11. The truss structure according to claim 1, wherein the truss structure's inner element provides the truss structure named “Mixed Quadrilateral-2 Triangles” by adding outer struts on each inner element edge to form two triangles of equal size.

12. The truss structure according to claim 1, wherein the outer struts are added on each inner element edge of the truss structure's inner element to form three equal-sized triangles.

13. The truss structure according to claim 1, wherein the truss structure's inner element provides the truss structure named “Mixed Quadrilateral-3 Triangles” by adding outer struts on each inner element edge to form three triangles of equal size.

14. (canceled)

15. (canceled)

16. The truss structure according to claim 1, wherein the outer struts are added on each inner element edge of the truss structure's inner element to form two equal-sized triangles.

17. The truss structure according to claim 1, wherein the truss structure's inner element provides the truss structure named “Mixed Hexagonal-2 Triangles” by adding outer struts on each inner element edge to form two triangles of equal size.

18. The truss structure according to claim 1, wherein the outer struts are added on each inner element edge of the truss structure's inner element to form three equal-sized triangles.

19. The truss structure according to claim 1, wherein the truss structure's inner element provides the truss structure named “Mixed Hexagonal-3 Triangles” by adding outer struts on each inner element edge to form three triangles of equal size.

20. The truss structure according to claim 1, comprising a unit cell comprising six truss structures when the truss structure's inner element has a triangular geometric form, and one truss structure when the truss structure's inner element has a quadrilateral or hexagonal geometric form.

21. The truss structure according to claim 1, comprising a two-dimensional lattice created by joining of the unit cells comprising the truss structure at the apex of the triangles formed by the outer struts.

22. The truss structure according to claim 1, comprising auxiliary struts placed in the truss structure's inner element and improving the mechanical performance of the truss structure's inner element to which they are attached.

23. The truss structure according to claim 1, characterized by comprising a lattice structure in the form of a first cylindrical tube obtained by folding a two-dimensional lattice created by joining unit cells comprising the truss structure at the apex of the triangles formed by the outer struts around any axis on the plane.

24. The truss structure according to claim 1, comprising a lattice structure in the form of a second cylindrical tube obtained by folding a two-dimensional lattice created by joining unit cells comprising the truss structure at the apex of the triangles formed by the outer struts around any axis on the plane.
